(19) United States
(12) Patent Application Publication
(10) Pub. No.: US 2025/0262626 A1
(43) Pub. Date: Aug. 21, 2025

(54) PRODUCTIVITY MONITOR IN MATERIAL REDUCTION OR SEPARATING MACHINE

(71) Applicant: Vermeer Manufacturing Company, Pella, IA (US)

(72) Inventors: Cody Raine Simpson, Monroe, IA (US); Joshua Aaron Youngblut, Knoxville, IA (US); Matthew David Greenawalt, Monroe, IA (US); Jeffrey Dean Bradley, Pella, IA (US); James Lee O'Halloran, Pella, IA (US); Abigail Joy Terpstra, Leighton, IA (US); Cole Richard Thompson, Ankeny, IA (US); Max Thomas Halstead, Roland, IA (US)

(21) Appl. No.: 18/859,347

(22) PCT Filed: Apr. 26, 2023
(86) PCT No.: PCT/US2023/019930

§ 371 Date: Oct. 23, 2024

Related U.S. Application Data
(60) Provisional application No. 63/335,395, filed on Apr. 27, 2022.

(51) Int. Cl. B02C 25/00; B02C 21/02; B02C 23/08

(52) U.S. Cl. CPC B02C 25/00; B02C 23/08; B02C 21/02

(57) ABSTRACT

A method of operating a material reduction or separating machine includes operating the machine with power from a power system to produce an outlet stream of material. The volume of the outlet stream of material is monitored, as is consumption of the power system from the operation of the material reduction or separating machine. With an on-board controller of the material reduction or separating machine a productivity measure is calculated as a unit volume per unit consumption. The productivity measure is displayed on an operator's display during the operation of the material reduction or separating machine to produce the outlet stream of material.

### CROSS-REFERENCE TO RELATED APPLICATIONS

This application claims the benefit of priority to co-pending U.S. Provisional Patent Application No. 63/335,395, filed Apr. 27, 2022, the entire contents of which are incorporated by reference herein.

### BACKGROUND

The invention relates to mobile processing machines, such as grinders or material separating machines (e.g., screening machines such as rotary trommels). Grinders and separating machines receive loads or streams of input material and subsequently process the material to produce one or more output streams. The machines, which can have numerous adjustable operating parameters or configurations, are largely controlled by human operators who must use their knowledge to control the machine to achieve various performance metrics, such as production rate, efficiency, etc. These machines include operator control stations with detailed displays to allow the operator to monitor certain parameters. However, it remains difficult for an operator to observe all of the available data and adjust their control strategy for desired performance, or for an operator to know how close the current performance is to optimal. Furthermore, the machine may be operated by multiple different operators. Manufacturer recommendations for machine setup and control strategy, along with some automated control programs, can be helpful in at least avoiding poor performance.

### SUMMARY

In one aspect, the invention provides a mobile processing machine, such as a grinder or material separating machine, and an operating method, in which the operator is provided a dynamic learning experience for controlling the productivity of the machine during use in the field. This can be accomplished in some aspects by providing real time display to the operator of a productivity measure as a unit of output material volume per unit consumption.

The productivity measure on the display changes in real time and may correspond to a change to the machine's operating settings or configuration made by the operator to directly show the productivity impact of the operator's change to the operator via the display.

In another aspect, the invention provides a method of operating a material reduction or separating machine, including operating the machine with power from a power system to produce an outlet stream of material. The volume of the outlet stream of material is monitored, as is consumption of the power system from the operation of the material reduction or separating machine. With an on-board controller of the material reduction or separating machine a productivity measure is calculated as a unit volume per unit consumption. The productivity measure is displayed on an operator's display during the operation of the material reduction or separating machine to produce the outlet stream of material.

In another aspect, the invention provides a material reduction or separating machine including a power system and a processing unit operable by the power system to process material fed into the material reduction or separating machine. An outlet conveyor is configured to receive processed material from the processing unit. A first sensor is operable to monitor material volume along the outlet conveyor. A second sensor is operable to monitor consumption of the power system from the operation of the material reduction or separating machine. An on-board controller of the material reduction or separating machine is connected with the first and second sensors and programmed to calculate a productivity measure as a unit volume per unit consumption from data provided from the first and second sensors. An operator's display is connected with the controller and configured to display the productivity measure during operation of the processing unit.

In yet another aspect, the invention provides a method of operating a material reduction or separating machine. A processing unit of the material reduction or separating machine is operated for a first duration with power from a power system to produce an outlet stream of material, the processing unit having a first replaceable component. The first replaceable component is detected with an on-board RFID reader. During the first duration, volumetric productivity of the processing unit per unit consumption of the power system are monitored and displayed with a controller and a display. Operation of the processing unit is stopped and the processing unit is modified to include a second replaceable component instead of the first replaceable component. The second replaceable component is detected with the on-board RFID reader. The processing unit is operated for a second duration with the second replaceable component installed. During the second duration, updated volumetric productivity measure per unit consumption is monitored and a contrast between the volumetric productivity of the first duration and the updated volumetric productivity of the second duration is displayed.

### BRIEF DESCRIPTION OF THE DRAWINGS

FIG. 1 is a perspective view of a rotary screening trommel machine for material separation according to one embodiment of the present disclosure.

FIG. 2 is a perspective view of a screen drum assembly of the rotary screening trommel machine of FIG. 1.

FIG. 3 is a perspective view of one removable screen of the screen drum assembly of FIG. 2.

FIG. 4 is a perspective view of a material outlet conveyor of the rotary screening trommel machine of FIG. 1, including a lidar sensor configured to detect volume of material output.

FIG. 5 is a detail view of the lidar sensor of FIG. 4.

FIG. 6 is a perspective view of a horizontal grinder according to one embodiment of the present disclosure.

FIG. 7 is a detail view of a portion of the horizontal grinder of FIG. 6 having portions of the exterior removed to illustrate a grinding mechanism thereof.

FIG. 8 is a side elevation view of the portion of the horizontal grinder of FIG. 7.

FIG. 9 is a perspective view of a removable screen of the horizontal grinder of FIG. 6.

FIG. 10 is a perspective view of a tub grinder according to one embodiment of the present disclosure.

FIG. 11 is an exemplary display configuration for an operator control station display for any of the rotary screening trommel of FIG. 1, the horizontal grinder of FIG. 6, or the tub grinder of FIG. 10.

FIG. 12 is an exemplary operator control panel for any of the rotary screening trommel of FIG. 1, the horizontal grinder of FIG. 6, or the tub grinder of FIG. 10.

FIG. 13 is an exemplary graph of productivity vs. time for the operator control station display, the graph plot representative of productivity reduction over time due to component wear.

FIG. 14 is an exemplary graph of productivity vs. time for the operator control station display, the graph plot representative of productivity difference between operators.

FIG. 15 is an exemplary graph of productivity vs. time for the operator control station display, the graph plot representative of productivity changes due to input material change and due to change in machine parameter/component.

FIG. 16 is an exemplary graph of productivity vs. time for the operator control station display, the graph plot representative of productivity changes due to multiple changes in machine parameters/components.

### DETAILED DESCRIPTION

Before any embodiments of the present invention are explained in detail, it is to be understood that the invention is not limited in its application to the details of construction and the arrangement of components set forth in the following description or illustrated in the following drawings. The invention is capable of other embodiments and of being practiced or of being carried out in various ways.

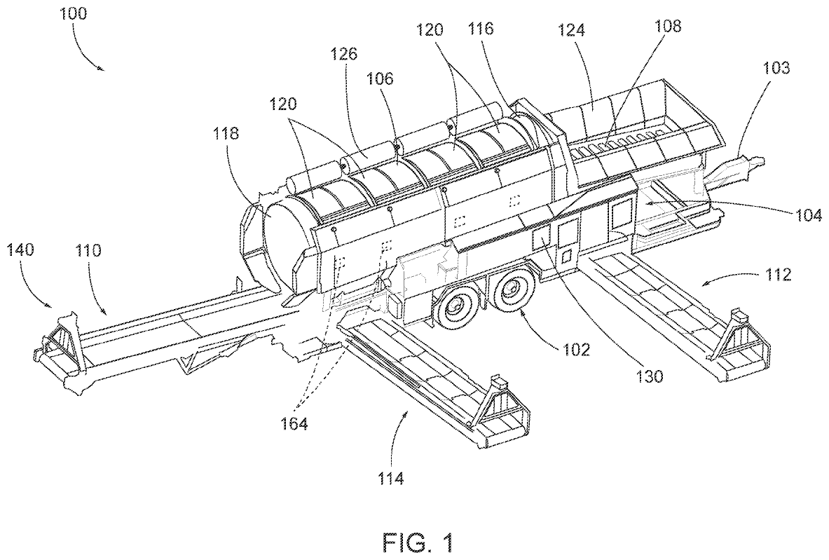

FIG. 1 illustrates a rotary screening trommel machine 100, or simply “screening machine 100” for material separation. The screening machine 100 can have basic functions and features consistent with conventionally known machines, in addition to one or more features which are the subject of the present disclosure. Conventional features of the rotary trommel 100, which are also covered briefly herein, can be found in U.S. Pat. No. 10,118,197 or U.S. Patent Application Publication No. 2018/0340593, the entire contents of both of which are incorporated by reference herein. The screening machine 100 can be a mobile machine configured to be trailered by a vehicle to one or more work sites. As such, the screening machine 100 can include a trailer support with wheels 102 for ground support and a hitch 103 configured to be attached to a towing vehicle. Alternately, the screening machine 100 can be self-propelled, including a ground drive system such as a set of tracks that enable the screening machine 100 to drive itself around a work site. The screening machine 100 has an on-board power system 104, a rotary trommel screen 106 or “screen drum”, an inlet conveyor 108, an outlet conveyor 110, a forward side conveyor 112, and a rearward side conveyor 114. The screening machine 100 is configured to separate conglomerate material into separate constituent products (e.g., based on component sizing) delivered via the outlet conveyor 110 and the side conveyors 112, 114. As will become apparent from the following description, the side conveyors 112, 114 are “fines” conveyors configured to receive material of relatively small component size, and the outlet conveyor 110 is an “overs” conveyor configured to receive material of relatively large component size.

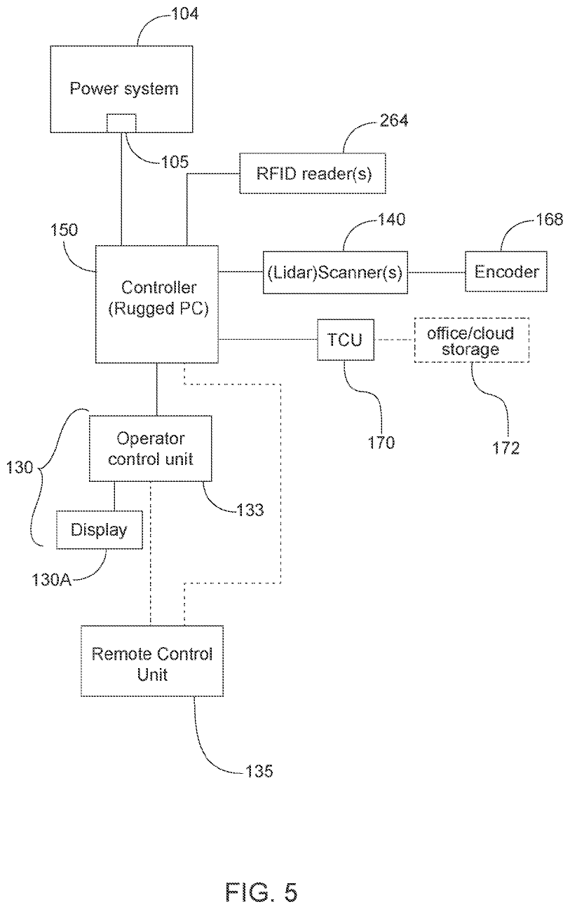

The power system 104 provides power to the screening machine 100 during operation. In some examples, the power system 104 includes a combustion engine. In some examples, the power system 104 is an electric power system. In some examples, the power system includes a fuel cell such as a battery. In some embodiments, the engine is a diesel engine. In addition, the power system 104 includes a hydraulic system. In some embodiments, the power system 104 and the screening machine 100, in their entirety, are operable remotely or by a control panel 130 that is operable by a human operator and in communication with the power system 104. The control panel 130, which constitutes part of the screening machine 100, can be built-in (e.g., integrated and hardwired) or removable (e.g., removable and configured to communicate wirelessly). Particularly, the control panel 130 can be or include any one or combination of a touch screen, remote controls (e.g., with touch screen or other input selectors), or a display with corresponding physical inputs such as buttons, switches, etc.). FIG. 5 schematically illustrates an on-machine control panel 130 including an operator control unit 133 and a display portion 130A. Separately indicated in FIG. 5 is an additional remote control unit 135, which may have some or all of the same controlling functions as the on-machine control panel 130. Likewise, it is to be understood that the power system 104 can be built-in and thus carried on the trailer support, or alternately can be remote, for example, in the form of the engine of the pulling vehicle (e.g., hydraulic connections to engine of the pulling vehicle being able to provide the drive to power the screening machine 100).

The rotary trommel screen 106 is configured to receive and filter conglomerate material. The rotary trommel screen 106 includes an inlet 116, an outlet 118, and a plurality of screen portions 120. In some embodiments, the rotary trommel screen 106 is generally cylindrical in shape. The rotary trommel screen 106 has an overall length measured from the inlet 116 to the outlet 118. In general, the rotary trommel screen 106 is configured to separate smaller material, proximate to the inlet 116, from larger material, which is removed proximate to, or from, the outlet 118. During operation, the rotary trommel screen 106 rotates about a longitudinal axis, which causes material contained with the rotary trommel screen 106 to be stirred and sifted. Additionally, in some embodiments, the rotary trommel screen 106 is mounted so that the rotary trommel screen 106 slopes downward from the inlet 116 to the outlet 118. Such a slope encourages material to travel from the inlet 116 to the outlet 118 during operation. Brushes 126 can be provided along an outside surface of the rotary trommel screen 106, e.g., at a fixed upper position, to wipe or brush the outside of the rotary trommel screen 106 as it rotates.

The inlet 116 of the rotary trommel screen 106 is configured to receive a conglomerate material. In some embodiments, the conglomerate material may be fed to the inlet 116 of the rotary trommel screen 106 by the inlet conveyor 108. Material can be introduced to the inlet conveyor 108 via a material hopper 124. In other embodiments, material may be fed to the inlet 116 by way of the material hopper 124 directly-without the inlet conveyor 108. The outlet 118 of rotary trommel screen 106 is configured to provide an opening for material (“oversize material”) that is not removed from the rotary trommel screen 106 by way of passing through the screen portions 120. The outlet conveyor 110 is configured to move material received from the outlet 118 of the rotary trommel screen 106 to a discharge location away from the screening machine 100. In the depicted embodiment, the outlet conveyor 110 is positioned longitudinally with respect to the rotary trommel screen 106. In some embodiments, the inlet and outlet conveyors 108, 110 are belt conveyors. The outlet conveyor 110 can have a variety of operating positions. The outlet conveyor 110 can also be folded and stowed on the screening machine 100 in a stowed positioned. When in the stowed position, the screening machine 100 can be transported. The side conveyors 112, 114 may be similarly configured.

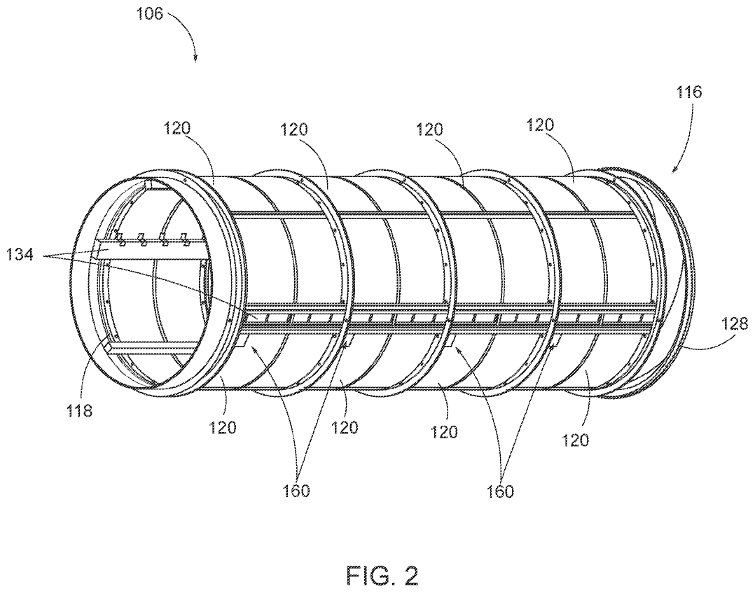

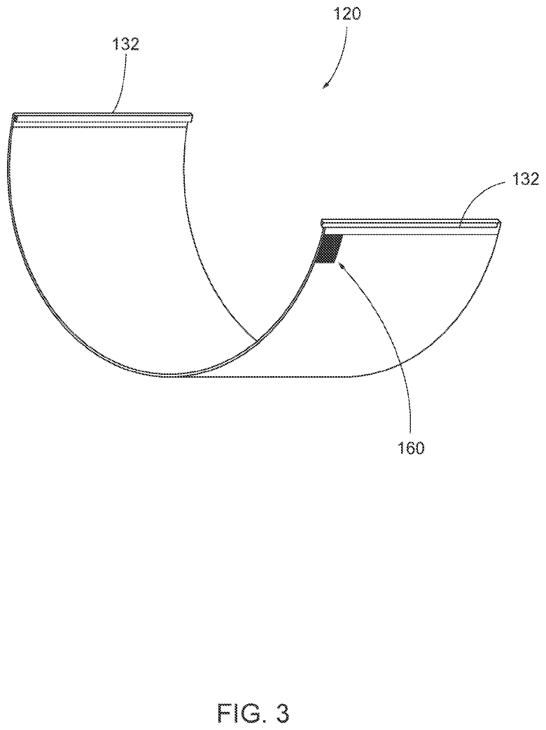

As shown in FIG. 2, the rotary trommel screen 106 can be in the shape of a hollow cylinder or drum and made up of a plurality of the screen portions 120. At the longitudinal end with the inlet 116, the rotary trommel screen 106 includes a drive sprocket 128 configured to be driven by the power system 104 to rotate the rotary trommel screen 106. As shown, each screen portion 120 forms a 180-degree semi-circle such that each longitudinal section (of which there are four in the illustrated embodiment) of the rotary trommel screen 106 is made up of a pair of screen portions 120. All the screen portions 120 can be identical to each other for interchangeability, and one exemplary screen portion 120 is shown in FIG. 3. The two opposite longitudinally-extending ends 132 (e.g., flanged ends) of the arcuate screen portions 120 can be configured for making fastener joints or otherwise securing with portions of a drum frame 134 (FIG. 2) of the rotary trommel screen 106.

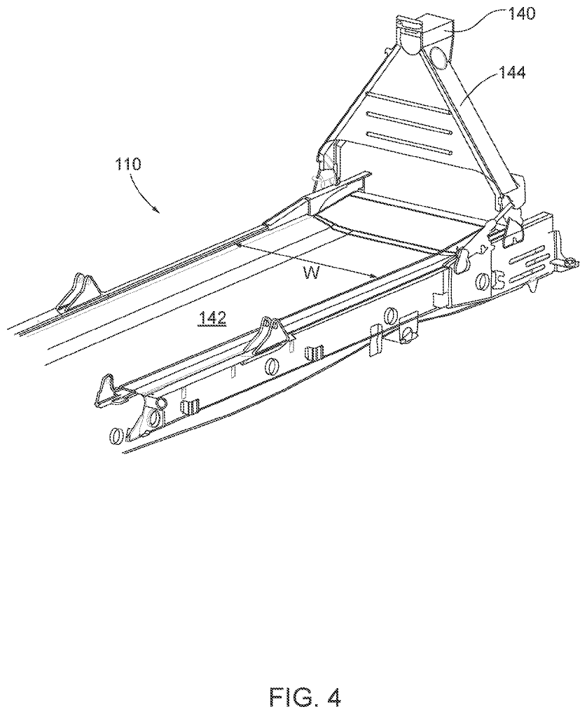

Turning now to FIGS. 4 and 5, the screening machine 100 includes, along the outlet conveyor 110, a scanner in the form of a lidar sensor 140, otherwise known as a laser profiler. In one non-limiting example, the lidar sensor 140 can be a Bulkscan® LMS511-20190 flow sensor from SICK AG, Waldkirch, Germany. The lidar sensor 140 is mounted at a position above, and aimed at, the material-receiving surface 142 of the outlet conveyor 110. According to the illustrated embodiment, the lidar sensor 140 is supported on a generally triangular bracket 144 positioned at the outlet end of the outlet conveyor 110. However, the lidar sensor 140 can be positioned further upstream in other constructions. Moreover, the lidar sensor 140 can be mounted to or adjacent the outlet conveyor 110 in other ways, such as a singular arm. The bracket 144 positions the lidar sensor 140 centrally along a width W of the outlet conveyor 110. The lidar sensor 140 is configured to have a full-width view of the material-receiving surface 142. As such, during operation, the lidar sensor 140 has a full view of the material supported on and conveyed by the outlet conveyor 110. The lidar sensor 140 is an example of a production volume sensor.

The side conveyors 112, 114 can be configured with lidar sensors 140, similar to that of the outlet conveyor 110 as described above. As such, the screening machine 100 is configured to measure the total material output (by volume) from the rotary trommel screen 106, including both the “fines” that pass through the screen portions 120 to the side conveyors 112, 114 and the “overs” that pass out of the rotary trommel screen 106 through the outlet 118. The lidar sensors 140 are connected for data communication with a controller 150 as schematically illustrated in FIG. 5. In some constructions, the controller 150 can be embodied in or incorporated with a rugged PC on board the machine 100. The controller 150 is also connected for data communication with the power system 104 and the control panel 130. In some constructions, the controller 150 communicates with the power source 104 (e.g., the combustion engine) via CAN bus protocol. This communication can include data provided to the controller 150 regarding consumption by the power system 104 (e.g., fuel consumption). For example, the power system 104 can include a sensor 105 (e.g., fuel flow) configured to measure the power system consumption. Where the power source 104 is instead an electrical power source, the sensor 105 may measure consumption (i.e., electrical power consumption, in kilowatt-hours or Joules). In some embodiment, the controller 150 may calculate or convert the electrical power consumption into alternate units, such as kWh. In concert with the consumption data, the controller 150 also keeps track of the volumetric output of the screening machine 100 via the lidar sensors 140, and the controller 150 is programmed to calculate a productivity measure as a unit volume per unit consumption. Although time may be taken into account when making the productivity measure (e.g., calculating via a current volume rate and a current consumption rate), the productivity measure is not a rate measure. In other words, the productivity measure does not inherently go up with a faster production of volumetric rate on the conveyors 110, 112, 114. In fact, the productivity measure may go down if consumption increases more dominantly than the increase in volumetric output rate. Thus, the productivity measure is an overall efficiency measure that measures total output amount against consumption required to produce the output amount.

The controller 150 communicates with the control panel 130 (e.g., a display screen 130A thereof) to display the productivity measure for observation by the operator during the operation of the screening machine 100. The productivity measure can be displayed to the operator in real time. In some constructions, the productivity measure can also be saved and/or downloaded. The controller 150 may include one or more electronic processors and one or more memory devices. The controller 150 may be communicably connected to one or more sensors or other inputs, such as described herein. The electronic processor may be implemented as a programmable microprocessor, an application specific integrated circuit (ASIC), one or more field programmable gate arrays (FPGA), a group of processing components, or with other suitable electronic processing components. The memory device (for example, a non-transitory, computer-readable medium) includes one or more devices (for example, RAM, ROM, flash memory, hard disk storage, etc.) for storing data and/or computer code for completing the or facilitating the various processes, methods, layers, and/or modules described herein. The memory device may include database components, object code components, script components, or other types of code and information for supporting the various activities and information structure described in the present application. According to one example, the memory device is communicably connected to the electronic processor and may include computer code for executing one or more processes described herein. The controller 150 may further include an input-output (“I/O”) module. The I/O module may be configured to interface directly interface with one or more devices, such as a power supply, sensors, displays, etc. In one embodiment, the I/O module may utilize general purpose I/O (GPIO) ports, analog inputs/outputs, digital inputs/outputs, and the like.

With respect to FIG. 5, it is noted that components of this schematic diagram may have internal/integral controllers and/or memory features. Features or operations of the controller 150 can be centralized or distributed among plural physical controllers (e.g., chips or microprocessors), generally referred to herein as “the controller 150” for simplicity. For example, the scanner 140 may be equipped with an integrated controller and memory. The scanner 140 can be connected with the controller 150 via Ethernet. An encoder 168 is used to determine the conveyor speed and is connected to the scanner 140 (e.g., directly as opposed to being connected directly to the controller 150). The operator control unit 133, display 130A, and/or the remote control 135 may have buttons, touch screens, controls, switches, or the like to adjust machine settings and display settings. A telematics control unit (TCU) 170 can send and/or receive data from an external source 172, such as an office or cloud based storage system. The ability of the TCU 170 to send or receive data may depend upon cellular service/connectivity to the external source 172. When the TCU 170 is in a condition where data cannot be sent or received (no cellular service) the data is stored in a memory device on the machine. Fuel data may be provided to the controller 150 from the TCU 170 in some constructions.

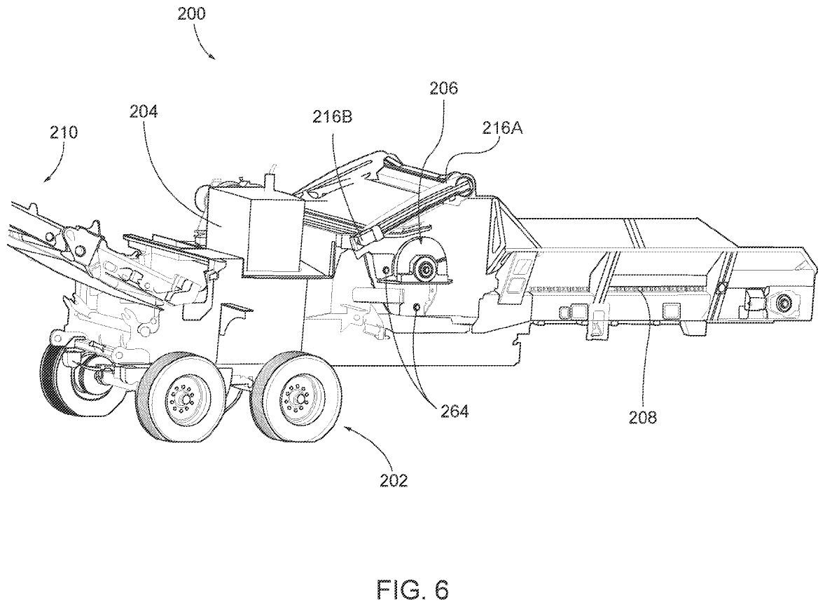

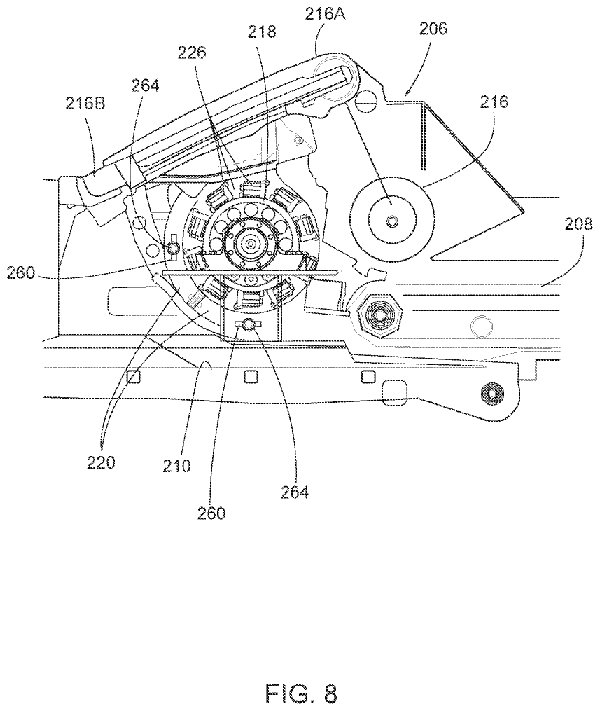

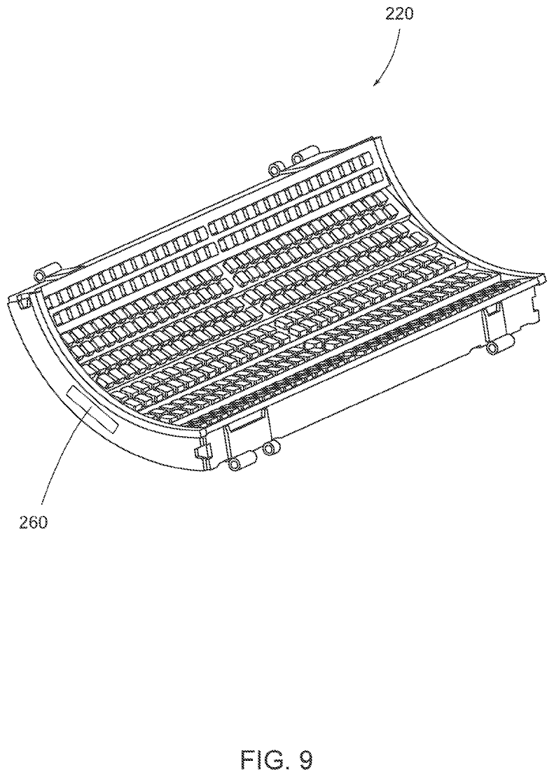

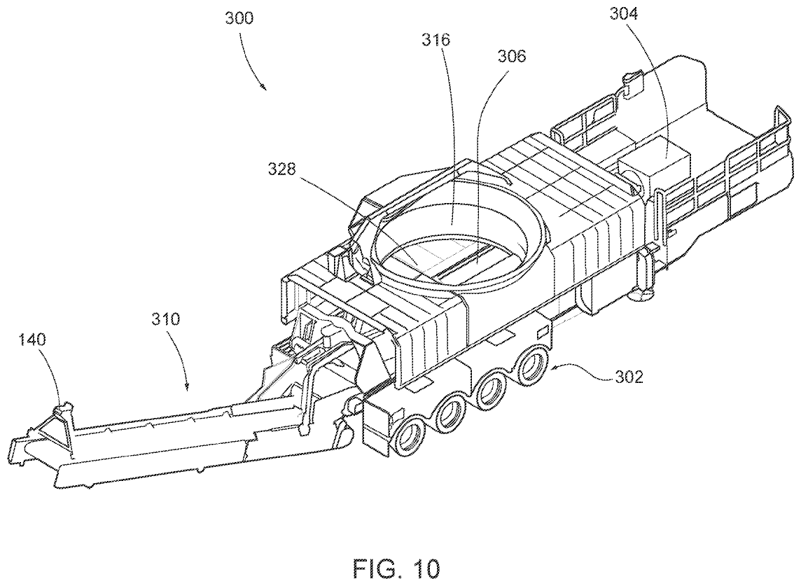

Before returning to describe additional detailed features relating to the productivity measure, the description is first directed to FIGS. 6-9 for a horizontal grinder 200, and FIG. 10 for a tub grinder 300, each of which can be configured similar to the screening machine 100 to calculate and display productivity measures. Each different type of machine has a different type of material processing unit for either reducing or screening the material provided into the machine.

As shown in FIGS. 6-9, the horizontal grinder 200 includes many general similarities with the screening machine 100, although they will be recognized as two different types of material processing machines that differ in the way in which they convert input material to processed output material. The horizontal grinder 200 can have basic functions and features consistent with conventionally known machines, in addition to one or more features which are the subject of the present disclosure. Conventional features of the horizontal grinder 200, which are also covered briefly herein, can be found in U.S. Pat. No. 9,192,964 or U.S. Pat. No. 9,254,492, the entire contents of both of which are incorporated by reference herein. The horizontal grinder 200 can be a mobile machine configured to be trailered by a vehicle to one or more work sites. As such, the horizontal grinder 200 can include a trailer support with wheels 202 for ground support and a hitch configured to be attached to a towing vehicle. Alternately, the horizontal grinder 200 can be self-propelled, including a ground drive system such as a set of tracks that enable the horizontal grinder 200 to drive itself around a work site. The horizontal grinder 200 has an on-board power system 204, a grinding mechanism 206, an inlet conveyor 208, an outlet conveyor 210. The horizontal grinder 200 is configured to comminute or reduce input material into smaller pieces or “chips” ejected via the outlet conveyor 210. The power system 204 provides power to the horizontal grinder 200 during operation. The power system 204 can take various forms, as described with respect to the screening machine power system 104, including a combustion engine. In some embodiments, the power system 204 and the horizontal grinder 200, in their entirety, are operable by a control panel (not shown) that can follow the general description of the control panel 130 above.

The grinding mechanism 206 is configured to receive material to be reduced from the horizontally extending inlet conveyor 208. Additionally, an upper feed roller 216 can cooperate with the inlet conveyor 208 to transport material to a material reducing chamber containing a rotary component 218 or drum on which a plurality of chipping knives 226 are fixed. The upper feed roller 216 can be mounted on a movable arm 216A that pivots at 216B to adjust the pressing force on the material between the upper feed roller 216 and the inlet conveyor 208. The rotary component 218, which can be driven by the power system 204 to rotate about a horizontal axis, operates such that the knives 226 come into close contact with a fixed anvil for reducing the material to smaller pieces. Partially surrounding the rotary component 218 is one or more screen portions 220 with sizing openings that selectively allow passage of reduced material from the material reducing chamber to the outlet conveyor 210. The outlet conveyor 210 can include one or more belt sections operable to remove the reduced material from the grinder 200. Although not shown, the outlet conveyor 210 can be configured like the outlet conveyor 110 of the screening machine 100 to include a lidar sensor 140, the function of which generally corresponds to that described for the screening machine 100. In other words, the lidar sensor 140 is mounted at a position above, and aimed at, the material-receiving surface of the outlet conveyor 210 and provided in data communication with a controller to keep track of the volumetric output of the horizontal grinder 200. As with the description of the prior embodiment, the controller is programmed to calculate a productivity measure as a unit volume per unit consumption.

As shown in FIG. 10, the tub grinder 300 includes many general similarities with the screening machine 100 and the horizontal grinder 200, although they will be recognized as two different types of material processing machines that differ in the way in which they convert input material to processed output material. The tub grinder 300 can have basic functions and features consistent with conventionally known machines, in addition to one or more features which are the subject of the present disclosure. Conventional features of the tub grinder 300, which are also covered briefly herein, can be found in U.S. Pat. No. 9,505,007, the entire contents of which are incorporated by reference herein. The tub grinder 300 can be a mobile machine configured to be trailered by a vehicle to one or more work sites. As such, the tub grinder 300 can include a trailer support with wheels 302 for ground support and a hitch configured to be attached to a towing vehicle. Alternately, the tub grinder 300 can be self-propelled, including a ground drive system such as a set of tracks that enable the tub grinder 300 to drive itself around a work site. The tub grinder 300 has an on-board power system 304, a grinding mechanism 306, and an outlet conveyor 310. The tub grinder 300 is configured to comminute or reduce input material into smaller pieces or “chips” ejected via the outlet conveyor 310. The power system 304 provides power to the tub grinder 300 during operation. The power system 304 can take various forms, as described with respect to the screening machine power system 104, including a combustion engine. In some embodiments, the power system 304 and the tub grinder 300, in their entirety, are operable by a control panel (not shown) that can follow the general description of the control panel 130 above.

Material is introduced to the grinding mechanism 306 via a rotary tub 316 which is rotatable on the tub grinder 300 about a vertical axis. At the bottom of the rotary tub 316 is a floor 328 having an opening in which a rotary component or drum is partially exposed. The rotary component has fixed thereon a plurality of hammers with corresponding cutters. The rotary component, which can be driven by the power system 304 to rotate about a horizontal axis, operates such that the combined action of the rotation of the tub 316 and the rotation of the rotary component reduces the material to smaller pieces. Partially surrounding the rotary component is one or more screen portions with sizing openings that selectively allow passage of reduced material from the material reducing chamber to the outlet conveyor 310. As shown at the left of FIG. 10, the outlet conveyor 310 can be configured like the outlet conveyor 110 of the screening machine 100 to include a lidar sensor 140, the function of which generally corresponds to that described for the screening machine 100. In other words, the lidar sensor 140 is mounted at a position above, and aimed at, the material-receiving surface of the outlet conveyor 310 and provided in data communication with a controller to keep track of the volumetric output of the tub grinder 300. As with the description of the prior embodiment, the controller is programmed to calculate a productivity measure as a unit volume per unit consumption.

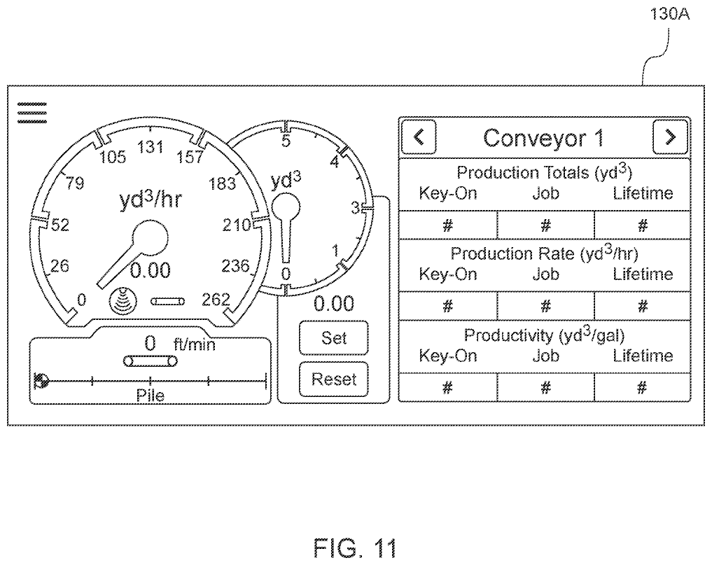

Turning to FIGS. 11 and 12, the control panel 130 (of any one of the screening machine 100, the horizontal grinder 200, the tub grinder 300, and also useful in any number of additional material processing machines, such as industrial chippers or shredders) is illustrated in further detail. FIG. 11 in particular shows an exemplary display presentation for the display portion 130A of the control panel 130. In addition to one or more gauges (e.g., volumetric rate in yd³/hr, and volume in yd³) on the left, the display portion 130A is controlled by the controller 150 to display production data in tabular form on the right. In constructions where the machine has more than one conveyor configured to received processed material, the production data tables can be conveyor-specific, and the display portion 130A can be cycled to change the production data tables to correspond to a certain conveyor. In some constructions, the data tables can represent production data from a plurality of conveyors, up to and including all the conveyors that receive processed material. The uppermost data row corresponds to production totals in volume units (e.g., yd³). This data can be parsed for separately displaying a key-on production total, a job production total, and a lifetime production total. The next data row corresponds to production rate in volume/time units (e.g., yd³/hr). This data can be parsed for separately displaying a key-on production rate, a job production rate, and a lifetime production rate. The next data row corresponds to productivity in unit volume per unit consumption (e.g., yd³/gal.). This data can be parsed for separately displaying a key-on productivity, a job productivity, and a lifetime productivity. Aspects of the disclosure may also encompass configurations or embodiments where a volumetric input of material being fed into the machine is known. When known, the volumetric input can be compared to the volumetric output of material. This may be useful for calibrating sensors and determining the ratio of material fractions. For example, in a trommel with multiple discharge conveyors, the fraction of the total input exiting from each conveyor can be determined.

As described above, the data can be configured to update in real time, or at least during the act of continued or ongoing material processing, for observation by the operator during use. In some constructions, the data can update with virtually no delay (i.e., only the required delay for the computer processing of the data) for instant feedback. On the other hand, updating at prescribed timing intervals can enable consistent material flow to be established, leading to smooth reliable data presentation. In some constructions, the data update interval is 1 minute to 10 minutes. In some constructions, the data update interval is 10 minutes to 20 minutes. In some constructions, the data update interval is 20 minutes to 30 minutes. As such, the operator can observe a productivity impact following a manual change to the machine's operating settings or configuration. Operating settings can in some circumstances be changed on-the-fly, for example adjusting a feed rate of input material, or adjusting an operating speed of a processing mechanism such as a rotary trommel screen or a rotary grinding or shredding component. However, the operator can also gain useful insight by noting the productivity values during one period of operation compared to another subsequent period of operation, where the physical configuration of the machine is changed in between. One such example is screen replacement (e.g., screen portions 120, 220), for example changing out screen portions for alternate screen portions having differently-sized openings. One or more knives or cutters can also be exchanged at a machine reconfiguration stoppage. In other circumstances, the operator can simply be changed out for a different operator, with no physical changes to the machine. The subsequent operator may vary one or more control parameters for running the machine and may achieve a different productivity measure. Discrete periods of machine use can also vary by the type of material input to the machine, resulting in a change in productivity that is displayed to the operator. Real time productivity feedback enables an operator to learn the effects of various changes and enables an operator to make further adjustments toward optimizing the productivity if that is their desired objective.

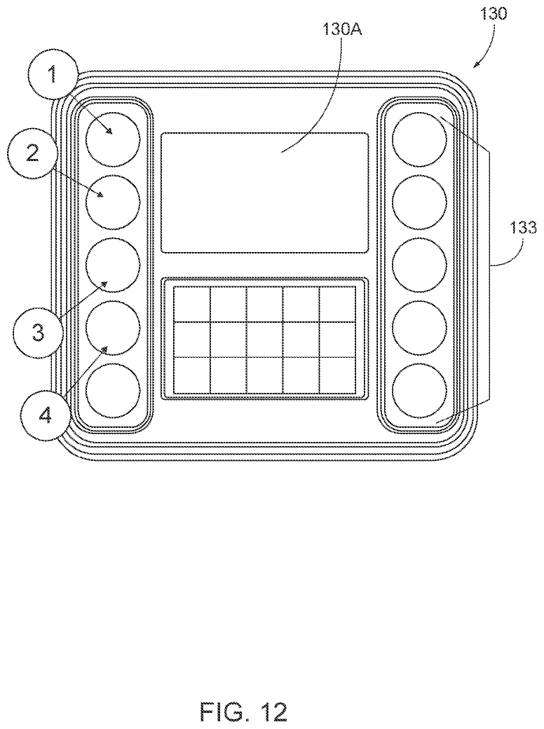

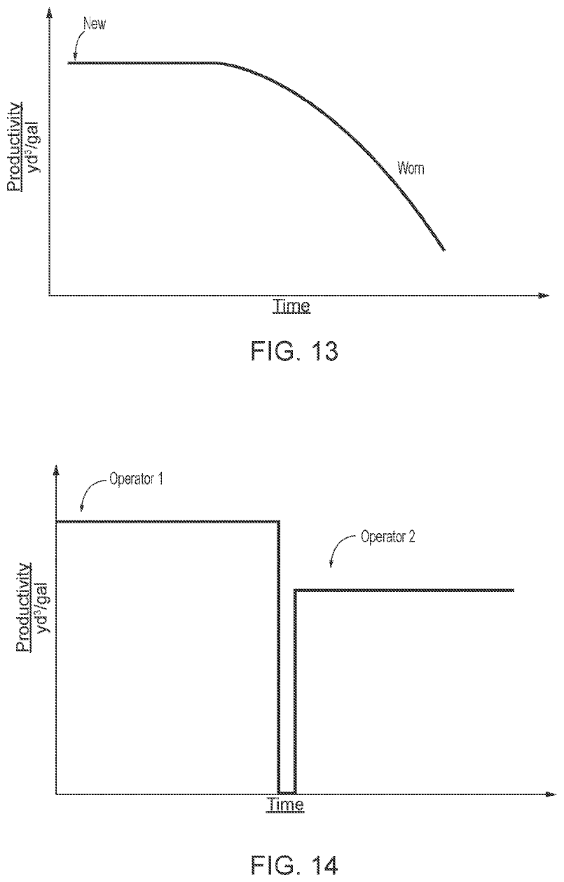

In addition to simply displaying the numerical values as in FIG. 11, graphical productivity information can be provided by the controller 150 and displayed at the control panel 130. Such information can also be stored in memory and/or transmitted to another device (e.g., via wireless communication) for observation. FIGS. 13-16 show a few specific examples of graphical productivity displays, each of which corresponds to a different particular scenario. In FIG. 13, the productivity vs. time plot begins at a high and consistent level, and this corresponds to the beginning of a component life cycle on the machine (e.g., cutters, knives, screens). As time progresses with continued running of the machine, the productivity begins a visually observable decline. In this case, the decline starts at a slow rate and then the rate of decline increases. Thus, the operator can visually observe the effect of worn componentry on productivity. The operator can decide at what point during the decline to stop running and replace components. In FIG. 14, the productivity vs. time plot begins at a first level corresponding to control of the machine by a first operator. At a particular time, there is an operator change, from the first operator to a second operator. The other aspects of the machine may remain the same (e.g., type of material being input, component configuration of the machine). The operator switch can include stopping running of the machine, as noted by the productivity briefly going to zero. In other constructions, the operators may switch on-the-fly. In any case, from the operator switching time, the productivity plot continues to display the productivity of the first operator next to the productivity of the second operator, giving the operator(s) the opportunity to compare productivity between the operators. In this way, an operator who may have less skill at optimizing the machine's productivity can be identified and further trained.

The system may be configured for one or both of the following options. The first option is manual comparison by the operator, where the user is able to compare the changes between different running scenarios (e.g., operator change, machine component change, setting change, etc.). The second option is for a computer program (either on-board or external) to compare the results of durations with different running scenarios. An alert(s) can be set to notify the operator if the productivity level is within or out of certain ranges, which can be preset and adjustable.

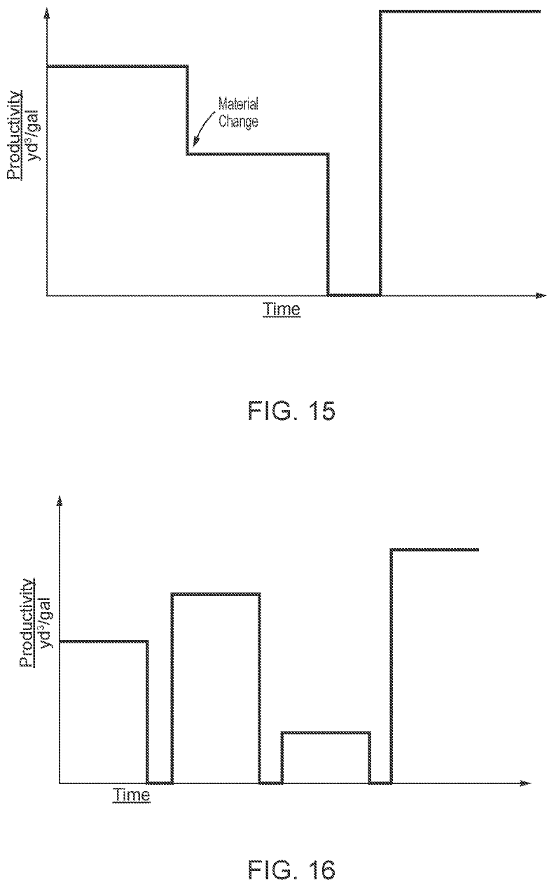

In FIG. 15, the productivity vs. time plot begins at a first level corresponding to the machine processing a first material. During a first period of time, the first material continues to be processed, and the machine's operating parameters and physical configuration are maintained and not adjusted. At a particular time, as noted in FIG. 15, there is a change from the first material to a second material. The productivity plot tracks the change in productivity resulting directly from the material change, giving the operator the opportunity to compare productivity between the first and second materials. For example, the operator may observe a drop in productivity, owing to the second material being processed in the initial machine settings. After processing the second material for a period of time, the operator can make adjustments to the machine (an operating parameter, or a physical configuration via component changing), for example in an attempt to increase the productivity value. The machine operation may be stopped by the operator as shown by the brief period of zero productivity, or the changes may be made on-the-fly. As shown by the final period on the plot of FIG. 15, the change(s) made result in increased productivity, at or above the first and second productivity values. Although the operator may choose to make multiple adjustments at one time, it is also possible to make two or more sequential adjustments in a one-at-a-time manner, so that the direct results of each can be seen with respect to productivity effect. In FIG. 16, the productivity plot shows an elapsed running time including three machine changes made by the operator (e.g., having optional respective stoppages therebetween). From the initial productivity, the first change results in a slight productivity increase. The second change results in a productivity reduction, in this case, even below the initial productivity. The third change results in a productivity increase that exceeds the productivity value after the first change.

With respect to FIG. 12, the control panel 130 offers a plurality of operator input selectors (e.g., buttons, or alternately levers, dials, sliders, etc.) for changing operating parameters of the screening or material reduction machine. In other words, this enables the operator to change an adjustable setting of the machine from one setting to a different setting. The input selectors can provide one or more preset modes. In particular, input selectors 1-4 can correspond to four different factory preset modes. The preset modes, which may correspond to different material types, can reduce or eliminate the requirement for the operator to make individual control selections. Additional input selectors of the operator control unit 133 are configured to give the operator control of individual operating parameters for the machine. Examples specific to certain ones of the machine types disclosed herein are provided below. All modes and details disclosed thereof are non-limiting examples.

For the screening machine 100, there can be material preset modes providing a plurality (e.g., four) combinations of machine functions and speed settings available for screening different types of material. These preset modes are programmable and adjustable to allow customization of screening different types of products. The same can be true for other types of screening machines or grinders (e.g., the horizontal grinder 200 and the tub grinder 300). The operator may switch from one material preset to another during operation. Various presets can be modified by the operator and saved in their modified state for future use (e.g., based on an observed productivity increase). The drum can be reversed if necessary (only used when the screen is stalled, rare occurrence). Can also choose between remote controls 135 and ground station controls 130. Values displayed on the display 130A can include:
Preset engine speed (per selected mode): display ranges from 1000-2400 rpm
Preset drum forward speed (per selected mode): display ranges from 0-22 rpm in increments of 0.5 rpm. Speed setting applies to forward in normal operation.
Preset Hopper Conveyor Forward speed (per selected mode): display ranges from 0-18 fpm (feet per minute) in increments of 0.5 fpm. Speed setting applies to forward in normal operation.
Preset overs and rear fines conveyor speed (per selected mode): displays ranges from 10-100% in increments of 10%. Speed settings apply to forward in normal operation.
Drum Pressure (per selected mode): Display ranges from 1300-2900 psi in increments of 100 psi. This setting will stop the hopper conveyor when the pressure in the drum hydraulic circuit reaches the set value for 3 seconds. This acts as a smart feed control and helps avoid drum stalls. Use this setting with the “Hopper conveyor restart” feature. (The hopper conveyor restart selects the pressure change required in the drum to allow the hopper conveyor to return to forward motion after being stopped due to drum pressure reaching its max setting. The range is 100-500 psi in increments of 100 psi. For example, if drum pressure is set to 1500 psi on the main display, and hopper conveyor restart pressure set to 200 psi, when the drum pressure reaches 1500 psi or greater for three consecutive seconds the hopper conveyor will stop. It will restart when drum pressure drops to 1300 psi or less.
Preset Front Finds Conveyor/Auxiliary (per selected mode): Displays ranges from 10-100% in increments of 10% if front fines or an auxiliary circuit is present.
Current engine speed: displays current engine rpm. Allows for comparison of actual/current engine speed compared to the preset engine speed (first bullet point above).

For the horizontal grinder 200, the control panel 130 can enable adjustment of infeed controls as follows. Auto feed on/off—when active (A) displayed along with “S” smart grind or “Rev” (Auto Reverse) on the display. Auto feed grind mode will default to the grind mode currently selected. With Smart Grind control operation (such as grind mode 3 below), the feed roller and infeed conveyor will vary with engine speed and will stop feeding material when engine RPM drops below a preset droop, and will automatically restart when engine speed exceeds droop speed. With Auto Reverse active (Such as grind modes 1 and 2 below), infeed speed remains constant until the engine drops below the droop speed (or until a predictive algorithm is satisfied). Then infeed then reverses for a period of time (e.g., adjustable/programmable) or until engine returns to droop speed. The period of time can be 0.5-2 seconds in some constructions. In other constructions, the period of time can be 2-5 seconds in some constructions. In yet other constructions, the period of time can be 5-10 seconds. The infeed will resume forward motion as soon as engine speed recovers. Auto feed mode suggestions:
Select auto reverse (such as grind modes 1 and 2 below) for grinding large logs or when material has difficulty feeding into the mill. This non-proportional, plunging mode grinds large logs more efficiently by keeping material away from the cutting action until the mill returns to speed between each feed cycle.
Select SmartFeed (grind mode 3) for regrinding. This proportional feed mode maintains steady feeding.
When making adjustments, feed roller speed and infeed conveyor speed of approximately 100% is suggested as a good initial setting to achieve efficient grinding operation. Adjust the speeds up or down in 5% increments until optimal efficiency is determined.

Auto feed has an automatic feature that reverses the feed roller and feed table if either exceeds their maximum operating pressure for a specified time. An infeed stall message is shown on the display. If the infeed conveyor stalls because of maximum pressure, the infeed will reverse and display a message on the display. Auto feed engages the feed roller and feed conveyor in forward motion, increases engine speed to high idle (approximately 2030 rpm), lowers the thrown object defector, starts the discharge conveyor and engage to clutch allowing the power source to rotate the rotor/drum/cutter. The auto feed grind modes 1-3 are factory defaults but can be changed if desired:
Grind mode 1 (aggressive grinding) default settings:
   Droop Speed: 1600 rpm
   Feed type: auto reverse
   Feed table speed: 100%
   Feed roller speed: 100%
Grind mode 2 (general grinding) default settings:
   Droop speed: 1700 rpm
   Feed type Auto Reverse
   Feed table speed: 70%
   Feed roller speed 83%
Grind mode 3 (regrind) default settings:
   Droop speed: 1700 rpm
   Feed type: SmartFeed
   Feed table speed: 100%
   Feed roller speed: 83%

Pressing button 4 allows adjustment of the values for droop, feed table, feed roller speed, and auto feed type. Droop speed: 1400-1800 rpm: Feed table speed: 10-100%: Feed roller speed: 10-100%; Feed type: SmartFeed or Auto Reverse. From the above options it can be appreciated that choosing the correct machine options can important for efficient operation. Buttons of the operator control unit 133 can additionally provide manual adjustment of the following controls, to override certain aspects of the automated modes discussed above. Feed roller forward/reverse switch—manually control the rotation of the feed roller in the forward or reverse direction. Feed roller raise (crush), lower switch, and feed roller lock switch—manually control the raising and lowering (crush force) of the feed roller. “Auto feed” setting may affect the feed roller control switch. Applying down pressure to the feed roller may aid in pulling material into the mill/drum. Infeed conveyor controls allow the infeed conveyor to move forward or reverse. The discharge conveyor speed can be adjusted.

For the tub grinder 300, controls can be similar to the horizontal grinder 200, but without the infeed conveyor or infeed roller control since there is instead the rotating tub that has a speed control. Parameters:
Auto feed type: Stop, Rev, or Smart
   Stop—tub rotation speed remains constant until the engine drops below the droop speed. The rotation will resume forward motion as soon as engine speed recovers.
   Reverse—tub rotation speed remains constant until the engine drops below the droop speed. The rotation then reverses for 2-5 seconds (adjustable/programmable) or until engine returns to droop speed. The rotation will resume forward motion as soon as engine speed recovers.
   Smart—the tub rotation speed will vary with engine speed and will stop feeding material when engine RPM drops below a preset droop, and will automatically restart when engine speed exceeds droop speed.
Droop speed: 1400-1800 rpm (high idle approximately 2030 rpm)
Tub speed: 0-100%

Auto Feed Modes for the tub grinder 300 can include:
Grind mode 1 (aggressive grinding)
   Auto feed type: Auto Stop (Stop)
   Droop speed: 1400 rpm
   Tub speed: 90%
Grind mode 2 (general grinding)
   Auto feed type: Auto reverse (rev)
   Droop speed: 1400 rpm
   Tub speed: 60%
Grind mode 3 (regrind)
   Auto feed type: SmartFeed (Smart)
   Droop speed: 1400 rpm
   Tub speed: 35%

Although not explicitly shown, aspects of the invention can be applied to other processing machines than those explicitly shown in the drawings. These can be variations or improvements on trommels or grinders, or a different type of processing machine such as a slow-speed shredder, an example of which is provided in Vermeer Manufacturing Co.'s U.S. Pat. No. 11,484,886, the entire contents of which are incorporated by reference herein.

Processing machines (such as tub grinders, horizontal grinders, trommels, and/or shredders) have multiple screen configurations all resulting in different efficiencies and outputs, depending upon the type of material being reduced and the desired characteristics of the output product (chip size and shape). The characteristics of the output product may change as parts wear—which may result in an undesirable and/or unusable output. Using worn components (screens) may result in changes in efficiency of the processing machine. Additionally, changing screen types may result in a more desirable output product and/or may result in improved efficiencies of the processing machine. In one aspect, each of the machines disclosed above can optionally incorporate a component identification system. The component identification system can be a built in system including removable components that are uniquely coded, and a scanner or reader. The component identification system can be in data communication with the controller 150 and can be integrated into the productivity displays and/or stored information regarding productivity performance.

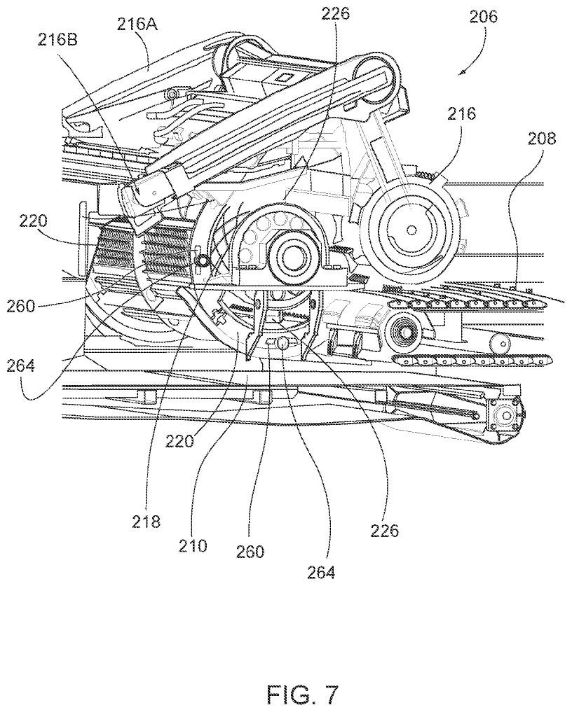

In some constructions, the component identification system can utilize RFID technology, for example high frequency RFID, which can optionally utilize IO-Link network communication protocol (or CAN bus protocol). At least one component (e.g., screen, cutter, knife, etc.) of the machine is provided with an ID tag (e.g., RFID tag) that includes coded identifying information relating to the component. See for example FIGS. 2 and 3, where the screen portions 120 of the screening machine 100 include respective RFID tags 160. Also, in the horizontal grinder 200, the screen portions 220 are shown with RFID tags 260 in FIGS. 7-9. The RFID tags 160, 260 can be located (e.g., on an outer rail or flange) on the screen portions 120, 220 so as to be positioned at an outer edge of the processing unit. As such, the RFID tags 160, 260 can be in position to be detected by respective RFID readers (see for example the RFID readers 164 of the screening machine 100 in FIG. 1 and RFID readers 264 of the horizontal grinder 200 in FIGS. 6-8). The RFID reader 264 is attached to the cutter mill housing in the illustrated embodiment. In some constructions, the identification system can utilize other standardized identification systems, including but not limited to barcodes and barcode readers, or QR codes and QR readers. In some constructions, any interfering components between the reader and ID tag may include an aperture to create a line of sight between the reader and the ID tag. However, RFID advantageously does not require direct line of sight to function properly and can read through foreign materials that may accumulate on or near the components of the identification system. The component(s) detected by the RFID reader(s) can be individually replaceable or replaceable as a set of two or more similar components.

The RFID reader identifies the component, which has unique physical traits and performance characteristics compared to other interchangeable versions of the component. The component information is collected by the control system where it is displayed to the operator. Additionally, the data may be sent external to the machine via telematics for data collection and analysis (e.g., to a job management entity and/or manufacturer). In some constructions, the component identification information is transferred to a rugged PC or other controller on the machine that may have memory. Reviewing this data allows the customer to understand the most efficient way to setup each machine. Collecting and saving the data also provides valuable information on best setups. Identification of the component (e.g., serial and/or part number), number of hours of use, recommended use (e.g., mulching, general griding, construction waste reduction), and physical characteristic(s) (e.g., screen hole size, shape, etc.) are examples of other data that can be recorded. Utilizing this data allows tracking of screen life and other component life (e.g., tracking knives or cutters in other material processing machines). The component identification information can but need not necessarily be integrated with the productivity data. In some constructions with integration, the productivity data can be displayed alongside of the screen identification. Further, a display that contrasts productivity for two different operating periods with two different replaceable components (e.g., screens) can be displayed with information identifying the first and second replaceable components.

Changes may be made in the above methods and systems without departing from the scope hereof. Also, aspects of various embodiments may be combined unless expressly prohibited. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

1. A method of operating a material reduction or separating machine, the method comprising:
operating a material reduction or separating machine with power from a power system to produce an outlet stream of material;
monitoring the volume of the outlet stream of material;
monitoring consumption of the power system from the operation of the material reduction or separating machine;
calculating with an on-board controller of the material reduction or separating machine a productivity measure as a unit volume per unit consumption; and
displaying the productivity measure on an operator's display during the operation of the material reduction or separating machine to produce the outlet stream of material.

2. The method of claim 1, wherein the power system includes a combustion engine, and the consumption is monitored in volume of consumed fuel.

3. The method of claim 1, wherein the power system is an electric power system, and the consumption is monitored in electrical power consumption.

4. The method of claim 1, wherein the volume of the outlet stream of material is monitored with a lidar sensor.

5. The method of claim 4, wherein the lidar sensor operates from an outlet conveyor mount to emit a laser output downward toward an outlet conveyor that moves the outlet stream of material.

6. The method of claim 1, further comprising monitoring the volume of at least one additional outlet stream of material produced from the operation of the material reduction or separating machine, wherein the productivity measure is calculated using the volume of the outlet stream of material and the at least one additional outlet stream of material.

7. The method of claim 1, wherein the productivity measure is displayed in real time on the operator's display during the operation of the material reduction or separating machine to produce the outlet stream of material.

8. (canceled)

9. The method of claim 1, wherein the material reduction or separating machine is operated for a first duration with an adjustable operating parameter in a first setting, the method further comprising:
the controller responding to an operator input to change the adjustable operating parameter from the first setting to a second setting;
calculating with the controller an updated productivity measure for a second duration, corresponding to the second setting, as a unit volume per unit consumption; and
displaying, concurrently on the operator's display, the productivity measure for the first duration and the updated productivity measure for the second duration.

10. The method of claim 1, wherein the material reduction or separating machine is operated for a first duration with a first replaceable component installed, the first replaceable component interacting directly with material processed by the material reduction or separating machine, the method further comprising:
stopping the operation of the material reduction or separating machine and changing out the first replaceable component for a second replaceable component;
restarting operation of the material reduction or separating machine with the second replaceable component installed;
calculating with the controller an updated productivity measure for a second duration, corresponding to the second replaceable component, as a unit volume per unit consumption; and
displaying, concurrently on the operator's display, the productivity measure for the first duration and the updated productivity measure for the second duration.

11. A material reduction or separating machine comprising:
a power system;
a processing unit operable by the power system to process material fed into the material reduction or separating machine;
an outlet conveyor configured to receive processed material from the processing unit;
a first sensor operable to monitor material volume along the outlet conveyor;
a second sensor operable to monitor consumption of the power system from the operation of the material reduction or separating machine;
an on-board controller of the material reduction or separating machine connected with the first and second sensors and programmed to calculate a productivity measure as a unit volume per unit consumption from data provided from the first and second sensors; and
an operator's display connected with the controller and configured to display the productivity measure during operation of the processing unit.

12. The material reduction or separating machine of claim 11, wherein the power system includes a fuel-burning combustion engine.

13. The material reduction or separating machine of claim 11, wherein the first sensor includes a lidar sensor.

14. The material reduction or separating machine of claim 13, wherein the lidar sensor is positioned on a mount above the outlet conveyor and is aimed downward toward the outlet conveyor.

15. The material reduction or separating machine of claim 11, further comprising an additional outlet conveyor and a third sensor operable to monitor material volume along the additional outlet conveyor, the controller programmed to calculate the productivity measure from data provided from the first, second, and third sensors.

16.-17. (canceled)

18. A method of operating a material reduction or separating machine, the method comprising:
operating a processing unit of the material reduction or separating machine for a first duration with power from a power system to produce an outlet stream of material, the processing unit having a first replaceable component;
detecting the first replaceable component with an on-board RFID reader;
during the first duration, monitoring and displaying volumetric productivity of the processing unit per unit consumption of the power system with a controller and a display;
stopping the operation of the processing unit and modifying the processing unit to include a second replaceable component instead of the first replaceable component;
detecting the second replaceable component with the on-board RFID reader;
operating the processing unit for a second duration with the second replaceable component installed; and
during the second duration, monitoring updated volumetric productivity measure per unit consumption and displaying a contrast between the volumetric productivity of the first duration and the updated volumetric productivity of the second duration.

19. The method of claim 18, further comprising detecting a third replaceable component with an additional on-board RFID reader, modifying the processing unit to include a fourth replaceable component instead of the third replaceable component, and detecting the fourth replaceable component with the additional on-board RFID reader, wherein the operating of the processing unit for the first duration includes operation with the third replaceable component installed, and wherein the operation of the processing unit for the second duration includes operation with the fourth replaceable component installed.

20. (canceled)

21. The method of claim 18, wherein the first replaceable component and the second replaceable component are screens through which processed material passes to reach an outlet conveyor.

22. The method of claim 18, wherein the displayed contrast between the volumetric productivity of the first duration and the updated volumetric productivity of the second duration includes information identifying the first and second replaceable components.

23. The method of claim 18, wherein the volumetric productivity is measured with a lidar sensor along an outlet conveyor that moves the outlet stream of material.

24. The method of claim 18, where each of the first and second replaceable components includes an RFID tag coded with data corresponding to the respective replaceable component, the RFID reader communicating the data to the controller upon the detection, the data being selected from the group consisting of:
an identification number,
a physical characteristic,
a recommended use, and
number of hours of use.
